(19) United States
(12) Patent Application Publication
(10) Pub. No.: US 2009/0037510 A1
(43) Pub. Date: Feb. 5, 2009

(54) METHOD AND SYSTEM FOR CONTACTING VISITORS TO AN ONLINE SYSTEM

(76) Inventor: HARVEY BECK, Toronto (CA)

Correspondence Address: BENNETT JONES LLP, 3400 ONE FIRST CANADIAN PLACE, PO BOX 130, TORONTO, ON, M5X 1A4, CA

(21) Appl. No.: 11/832,133

(22) Filed: Aug. 1, 2007

(51) Int. Cl. G06F 15/16

(52) U.S. Cl. 709/201

(57) ABSTRACT

A method and system for communicating with a user or a visitor to an online system. The visitor is provided with a contact page for a browser, which includes a field for inputting a query. The contact page further includes a field for posting a response. The contact page is bookmarked for access by the visitor. According to another embodiment, the contact page may include an email field, and the response is emailed to the user in addition to, or instead of, being posted on the contact page. According to another embodiment, the response is not emailed, but only posted on the contact page.

### FIELD OF THE APPLICATION

The present application relates to the Internet, and more particularly, to a method and system for communicating with a visitor to an online system.

### BACKGROUND OF THE APPLICATION

Email has become the de facto standard for communication today. An unfortunate side effect of the popularity of email is the proliferation of SPAM and other forms of unwanted email messages. In an effort to control the flood of unwanted email, Internet Service Providers (ISP's) have become more aggressive in their application and use of SPAM filters. While SPAM filters can be effective in blocking SPAM, the filters can also block legitimate emails from reaching the intended recipient(s).

Some online services or organizations require users to register in order to receive emails. While registration can serve to legitimize the users, email communications to the registered users can still be blocked by filters at the ISP, the email service and/or by software on the user's computer. Additionally, there may be instances where a user does not wish to register, i.e. the user wishes to remain an anonymous visitor.

Accordingly, there remains a need for improvements to address these shortcomings in the art.

### SUMMARY

The present application comprises a method, system and mechanism for communicating with visitors to an online system.

According to one embodiment, the present invention provides a method for providing a response to a visitor to an online system, the method comprises the steps of: displaying a browser page for the visitor, the browser page including an input field for receiving a query from the visitor; requesting the visitor to bookmark the browser page; formulating a response to the query from the visitor; posting the response on the browser page for the visitor; and allowing the visitor to access the browser page for the posted response using the bookmark.

According to another embodiment, the present invention provides a system for providing a response to a visitor to an online service, the system comprises: means for generating a contact page for display on a browser accessed by the visitor; the contact page including a field for receiving a query from the visitor; means for saving a response to the query; means for posting the response on the contact page associated with the visitor; means for the user to bookmark the contact page for accessing the contact page at another time.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments according to the present application, and in which:

FIG. 1 shows in flowchart form a process for creating a user contact according to an embodiment of the present invention;

FIG. 2 shows in flowchart form a process for responding to a user contact according to an embodiment of the present invention;

FIG. 3 shows a screen shot of a browser based contact form for an online service;

FIG. 4 shows a screen shot of a browser based personalized contact form for an online service according to an embodiment of the invention; and

FIG. 5 shows a screen shot of the browser based personalized contact form of FIG. 4 with a reply or response provided by the online service.

Like reference numerals indicate like or corresponding elements in the drawings.

### DETAILED DESCRIPTION OF THE EMBODIMENTS

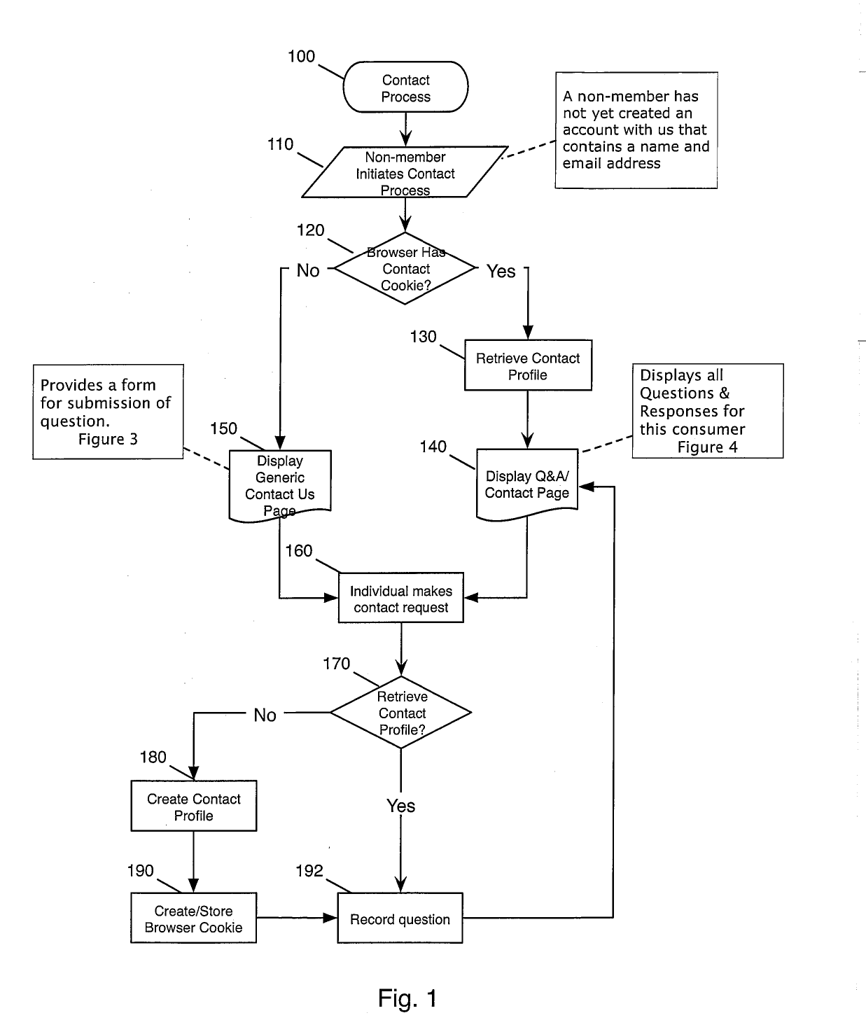

Reference is first made to FIG. 1, which shows in flowchart form a process for creating a user contact for a non-member or visitor to an online service according to an embodiment of the present invention. The process is indicated generally by reference 100.

In the context of the present description, a visitor or non-member is defined to mean a user or individual who accesses an online service, and wishes to remain anonymous, i.e. does not register or open an account, or does provide identification for further communication. In another aspect, a visitor or non-member is defined to mean a user who accesses an online service, but is not a registered user of the online service (e.g. has not yet created an account with the online service), nor does necessarily want or wish to become a registered user. According to another aspect, the system and method according to the present invention can be used by an organization (e.g. a corporation or a company office) in addition to the company's conventional email system.

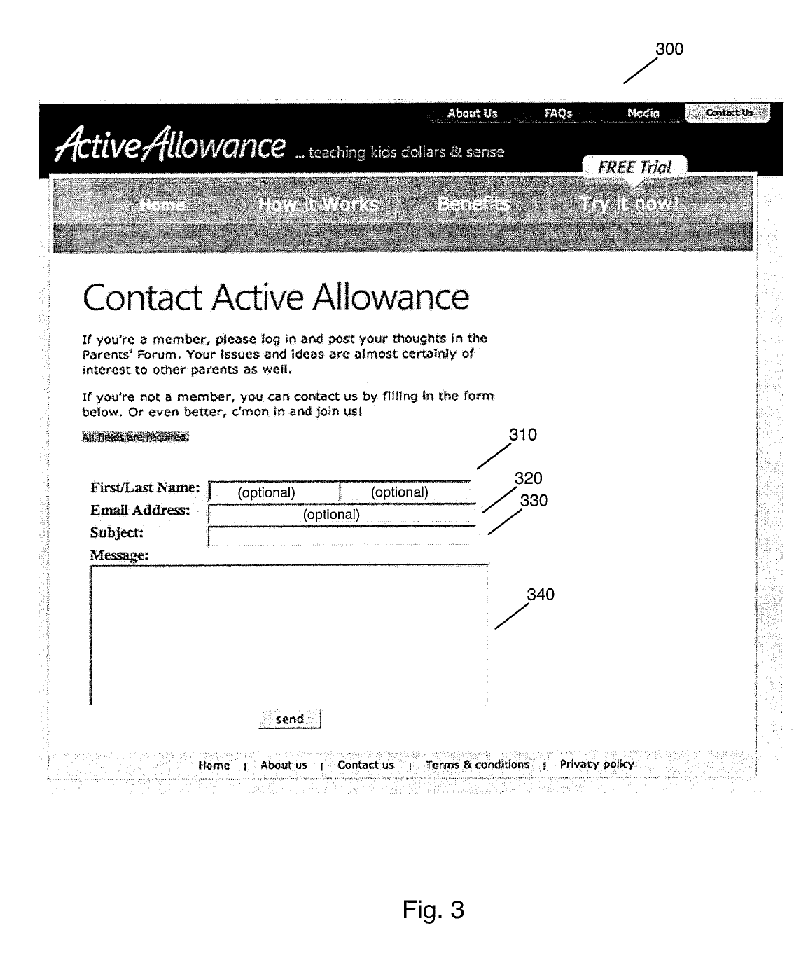

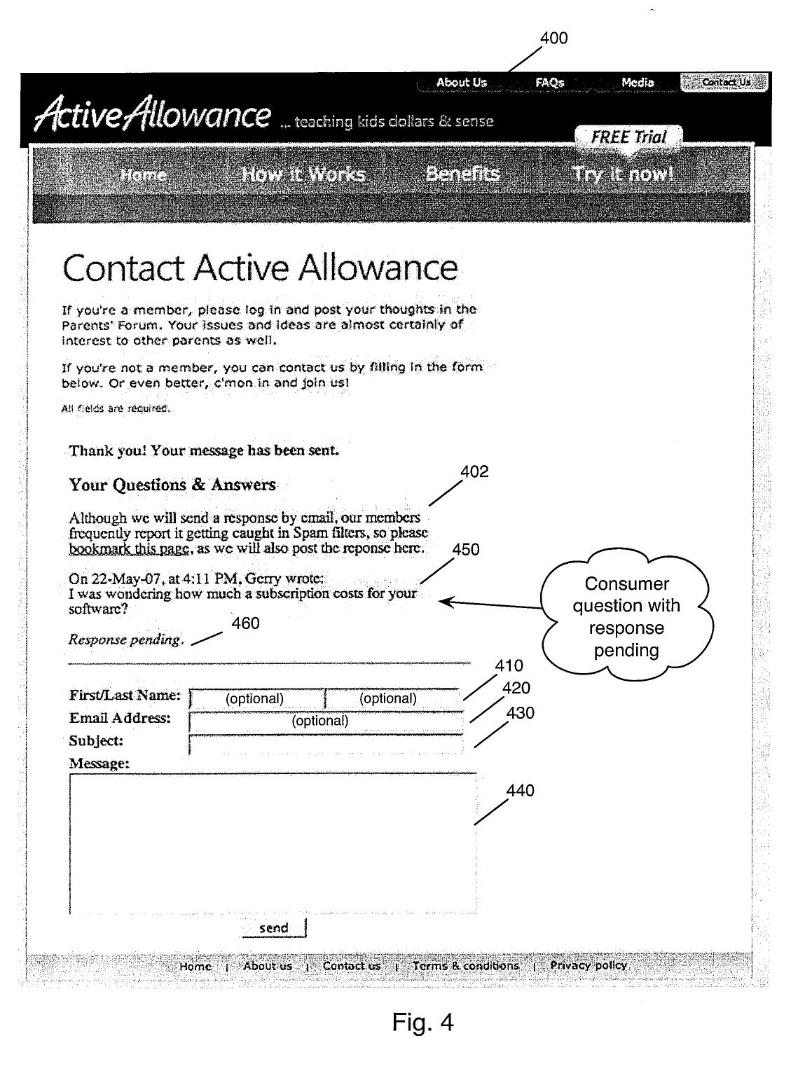

As indicated in block 110 in FIG. 1, a visitor or non-member initiates the contact process with an online service. The next step in the process for creating a user contact 100 comprises determining if the visitor has previously visited the online service and/or posed a question. According to one embodiment, the browser running on the user's computer is checked for a contact cookie as indicated in decision block 120. If the user doesn't have a contact cookie, then the visitor has not previously visited the service, and, for example, also posed a question. A generic “Contact Us” page or form is displayed as indicated by block 150. The contact page or form may take the form as shown in FIG. 3 and indicated by reference 300. The contact form 300 may comprise a browser based page and the user fills in a name field 310 and an email field 320. The contact form 300 may also include a subject field 330 and/or a message field 340. According to an embodiment, completion of the name field 310 and the email field 320 may be optional, for example, to allow a visitor to post a question in the message field 340 while remaining anonymous. If the visitor's browser has a contact cookie as determined in decision block 120, then the visitor has previously visited or made contact with the online service, and a contact profile would have been created for the visitor. The contact profile for the visitor is retrieved in block 130, and a personalized contact page or form may be displayed as indicated by block 140. The personalized contact page may comprise a browser-based page having a form as shown in FIG. 4 and indicated generally by reference 400, and described in more detail below.

The next step in block 160 involves the individual (i.e. visitor) making a contact request. The contact request may comprise the individual, for example, a new or first-time visitor, or a previous visitor (for example, as determined in decision block 120), entering a message, for example posing a question, in the message field 340 of the contact form 300. Next in decision block 170, a determination is made to retrieve the contact profile for the visitor. If the visitor is a first-time visitor (i.e. the visitor has not previously accessed the online service (and posed a question), then a contact profile is created as indicated in block 180, and a browser cookie is created/stored on the visitor's computer as indicated in block 190. In accordance with another embodiment the cookie is created after the visitor enters a question. In accordance with this aspect, the cookie includes information about the visitor (e.g. user), and provides a mechanism in the implementation of a messaging/communication system as described. If the visitor already has a contact profile (as determined in decision block 170), then a contact profile page personalized to the visitor is retrieved and displayed on the browser running on the visitor's computer and the visitor is provided with an opportunity to enter or record a question for the online system, as indicated in block 192. After the visitor enters a question, the contact page may be displayed or refreshed in block 140 to display the question.

The personalized contact profile page retrieved in step 170 may take a form as depicted in FIG. 4. Referring to FIG. 4, the personalized contact page or form 400 includes a visitor name field 410, an email field 420, a subject field 430 and a message field 440. According to one embodiment, filling in the visitor name field 410 and/or the email field 420 may be optional. For the personalized contact page 400 depicted in FIG. 4, the visitor had previously entered a question (i.e. in the message field 440) inquiring about the cost for software offered by the online service, and the question is displayed in a section of the page indicated generally by reference 450. The section 450 may also include a list or history of all or the most recent previously posted questions and responses. According to another aspect, a “Response pending” message is displayed by the online system (for example, the system administrator) at 460.

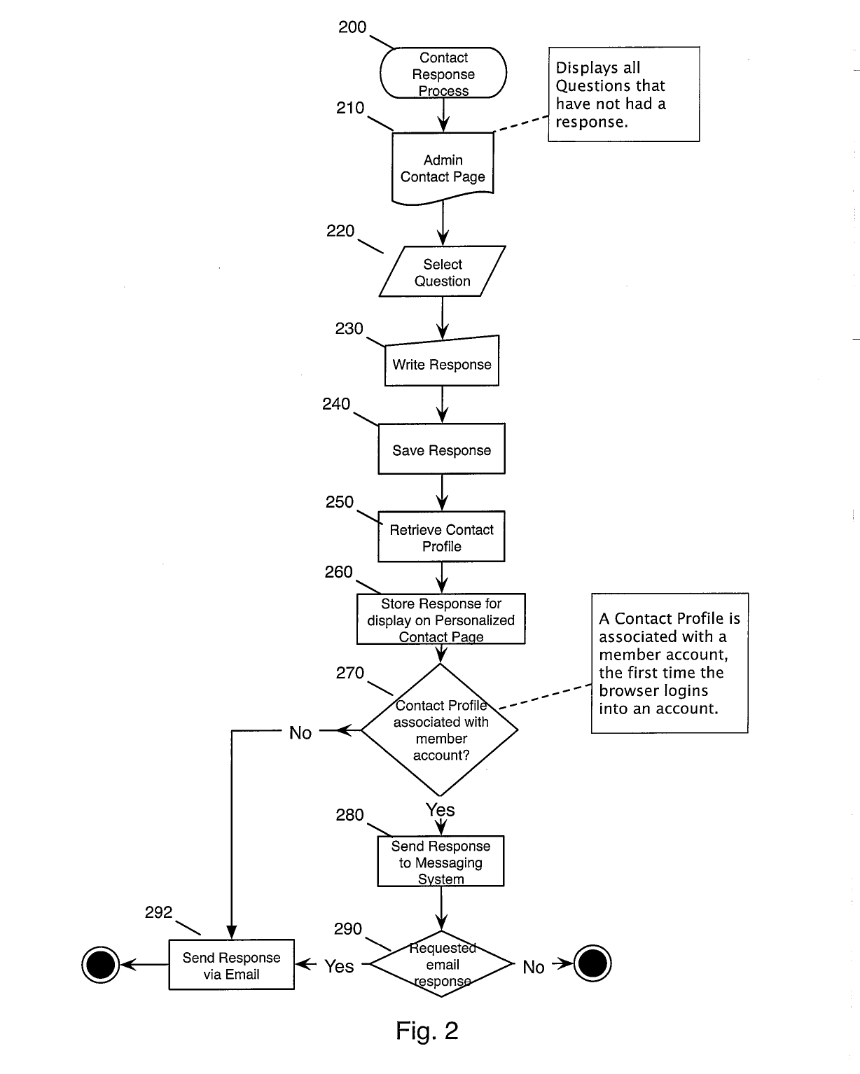

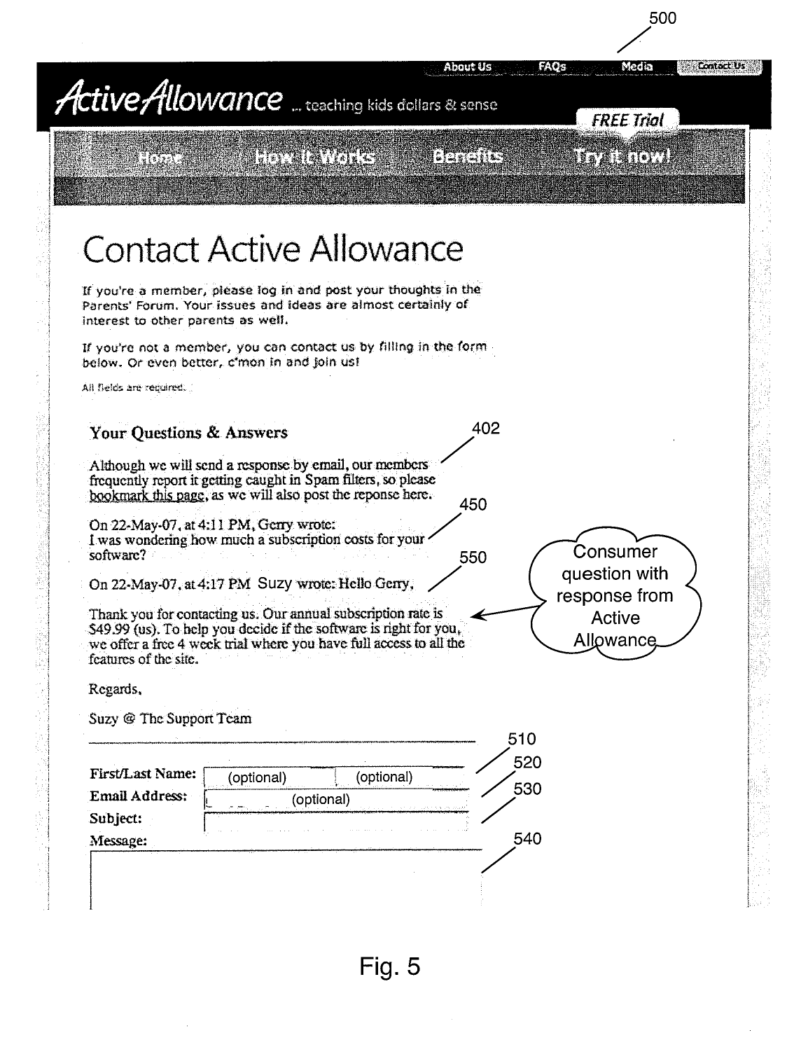

Reference is next made to FIG. 2, which shows in flowchart form a process or method performed by the online system for responding to a query from a user (i.e. visitor). The process is indicated generally by reference 200. The first step indicated by block 210 involves retrieving or displaying questions from users that have not been answered. The questions may be contained on an administrator contact page (as indicated in block 210) or a list or table retrieved from system memory. The system administrator or customer support selects a question from the page in block 220, writes a response in block 230, and saves the response in block 240. Next in block 250, the contact profile(s) for users(s) are retrieved, for example, automatically by the system or in response to an administrator action. The contact profile may include a link to or the personalized contact page (for example, having the form of the contact page 400 of FIG. 4). Next in block 260, the response (i.e. written or entered in block 230) is stored for display on the associated user's personalized contact page. The personalized contact page 400 as shown in FIG. 5 includes a field or section 550 for displaying the response generated by the system, e.g. the administrator.

Referring back to FIG. 2, next in step 270 a check is made to determine whether the contact profile (i.e. user) is associated with a member account, e.g. for the online service. According to an embodiment, the contact profile will be associated with a member account, the first time the user logins to an account. If the user has a member account, then the response is sent to a message center associated with the system or online service, as indicated in block 280. If the user has requested an email response (for example, as part of their profile) as determined in decision block 290, then the response is sent via an email as indicated by block 292. If the user has not requested an email response, then process terminates after step 290.

Referring again to FIG. 2, if contact profile is not associated with a member account, as determined in decision block 270, then a response is sent by email (as indicated in block 292) if the user has entered their email address, for example, in the contact form 300 described above with reference to FIG. 3. According to another embodiment, if the user has not elected not to enter an email address, then the response may be provided via the personalized contact page 400 as described below.

According to another aspect of the invention, the online system prompts the user at 402 to bookmark the personalized contact page 400 (FIG. 4). This provides a mechanism for the online system to communicate with the user in the event a SPAM filter blocks email message(s) from the online system, or according to another aspect, a mechanism for communicating with users (i.e. visitors) who wish to remain anonymous. The bookmarked personalized contact page 400 also allows the user to receive communication(s), for example, a response 240 (FIG. 2) from the online system using a browser program only and without the need for email. According to another embodiment, the user may receive both an email containing the response 292 (FIG. 2) and have the response posted on their personalized contact page 400, for example, in the response field as indicated by reference 550 in FIG. 5.

In summary and according to one aspect, the system and method according to an embodiment of the present invention allows a user, e.g. a visitor, to visit an online service and post a question and receive a response, while remaining anonymous, i.e. without the need to provide a name or other identifier and without the need to provide an email address.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method for providing a response to a user of an online system, said method comprising the steps of:
displaying a browser page for the user, said browser page including an input field for receiving a query from the user;
requesting the user to bookmark said browser page;
formulating a response to the query from the user;
posting said response on said browser page for the user; and
allowing the user to access said browser page for the posted response using said bookmark.

2. The method as claimed in claim 1, wherein the user is not a member of the online system.

3. The method as claimed in claim 1, further including an input field for receiving an email address from the user.

4. The method as claimed in claim 3, further including the step of determining if the user has entered an email address, and the step of sending an email containing said response to the user.

5. The method as claimed in claim 4, wherein said step of sending an email is performed in addition to said step of posting said response on said browser page.

6. A system for providing a response for a visitor to an online service, said system comprising:
means for generating a contact page for display on a browser accessed by the visitor;
said contact page including a field for receiving a query from the visitor;
means for saving a response to said query;
means for posting said response on said contact page associated with the visitor;
means for the user to bookmark said contact page for accessing said contact page at another time.

7. The system as claimed in claim 6, wherein said contact page includes a field for the visitor to enter an email address.

8. The system as claimed in claim 7, further including means for sending an email to the visitor wherein said email includes said response.

9. The system as claimed in claim 8, wherein said means for posting said response is operative in addition to said means for sending an email.

10. The system as claimed in claim 8, wherein said means posting said response is selectively operative, and said means for sending an email is inoperative when said means for posting said response is operative.

11. The system as claimed in claim 9, wherein said visitor is not previously associated with said online service.

12. The system as claimed in claim 6, further including means for posting one or more previous queries posted by the visitor, and one or more responses generated in response to said one or more previous queries.
